(19) United States
(12) Patent Application Publication
(10) Pub. No.: US 2002/0019777 A1
(43) Pub. Date: Feb. 14, 2002

(54) Return of merchandize through third party locations

(76) Inventors: David Michael Schwab, Glenmoore, PA (US); Frederick Odell Hawkes, Melbourne, FL (US)

Correspondence Address: JOEL I ROSENBLATT, 445 11TH AVENUE, INDIALANTIC, FL, 32903, US

(21) Appl. No.: 09/751,997

(22) Filed: Dec. 29, 2000

Related U.S. Application Data
(60) Provisional application No. 60/174,136, filed on Dec. 31, 1999.

(51) Int. Cl. G06F 17/60

(52) U.S. Cl. 705/26

(57) ABSTRACT

A third party establishment (agent) acts as an agent to an e-commerce or catalog merchant (merchant) and processes product returns for that merchant. The agent utilizes a computer system that is linked to the merchant's computer system that enables the agent to establish authenticity of the returned item and correlation to an original purchase, further enables the agent to establish whether or the not the return is acceptable per the merchant's return policies, and enables the agent, acting on behalf of the merchant, to issue financial credit instantly to the customer, provided the requirements for returning the item are satisfied. The system has the flexibility to then allow the agent to ship the returned product back to the merchant, or, alternatively, to ship the returned product directly to the original manufacturer or supplier (manufacturer). This system reduces handling, shipping and inspection costs and also improves customer satisfaction and loyalty by providing convenient, local return capability with immediate remuneration to the customer's financial instrument.

### CROSS REFERENCE to RELATED APPLICATONS

This Application is related to Provisional Patent Application No. 60/174,136, filed Dec. 31, 1999.

### FIELD OF THE INVENTION

The field of this invention is a system and method for using a computer data processor and computer based network communications for returning merchandise to a remote seller through a local third party.

### BACKGROUND OF THE INVENTION

In the commercial practices of e-commerce transactions, the purchase and delivery of merchandise may be completed over the internet using computer based network communications, with delivery accomplished to the buyer from the sellers remote location. Where the buyer decides to return the purchase, and unlike a purchase from a local seller, the internet buyer must reestablish contact with the internet seller, arrange for return shipment, receive verification from the seller the returned merchandise has been received and is acceptable as a return and the credit card account of the buyer has been properly credited. However, this arrangement requires time for the buyer to arrange for the return, to make the return and to receive credit and to have that credit in the buyer's account ready and accessible for a new purchase. This process may take days or longer, depending on the facilities available for shipment and accounting for the buyer credit. In the event a question arises related to the returned merchandise, confusion and more time may be added to the return process which is compounded by the remote location of the seller's facility designated for receiving, inspecting and accepting the return and for crediting the buyer's account. This method and system for returning merchandise acquired from a remote seller, to the remote seller, requires time, causes inconvenience and adds to the buyer's delay in gaining access to the return refund and a new purchase using that same refund.

### SUMMARY OF THE INVENTION

The rapid expansion of consumer purchases via the Internet and by telephone has resulted in an increasing need to efficiently and effectively handle returns of goods that consumers wish to return for exchange, store credit or money back (issuance of credits against the financial instrument, typically a credit card). Typically, a consumer receives items purchased from an e-commerce merchant or from a catalog merchant via a common carrier at the “ship to” location specified in the order placed with the merchant. Should the consumer wish to return an item, they typically need to re-package the item, obtain advance authorization from the merchant to return the item (typically a Return Material Authorization Number), and then arrange for the item to be shipped back directly to the merchant's return location. The consumer must then wait an unspecified length of time to receive acknowledgement of receipt of the returned item by the merchant and issuance of credit back to the consumer's original financial instrument. This process places a burden on the consumer when compared to a direct return by the consumer for example at a physical retail outlet, in which case the goods do not have to be re-packaged for shipment and credit to the financial instrument or an exchange is typically obtained immediately. In addition, items that are purchased by one customer and then given to a secondary recipient as a gift further complicate the return process. Recognizing these shortcomings, many e-commerce merchants and catalog merchants are starting to allow physical returns of purchased goods at their traditional local physical locations, often referred to as brick and mortar locations, should they have them. However, this has not addressed the issue for items that are only available via the Internet or a Catalog and has also not helped merchants that do not have a multitude of physical locations convenient to the customer in which to conduct return transactions.

The creation of a system and method that allows customers of e-commerce and catalog merchants to return purchased items to a third party that has a network of convenient physical locations without the necessity to package the items for shipment or to arrange said shipment and, furthermore, to immediately receive credit against their original financial instrument, or, alternately, arrange immediate shipment of an exchange product, is described below according to the disclosed inventive principles and a preferred embodiment and identified generally below as “DotComReturns.”

This invention, described in accordance with the disclosed inventive principles, provides a system and method for using computer based network communications, as would be known to those skilled in the art, to establish a third party local return site for merchandise purchased through the internet and for the seller or its third party authorized agent, to inspect and authorize the return and credit to the buyer for the return, at the time of the return at the third party's location.

According to the principles of the disclosed invention a system for a computer based information exchange network is established that enables a third party to act as an agent of an e-commerce or catalog merchant seller to consummate returns of purchased goods at a location which is local relative the buyer but remote relative to the seller's location. As would be understood by those skilled in the art, the use of the terms “local” and “remote” mean places where there is or is not a physical presence, and for a local place, where communications and exchanges may be made directly or face to face by a direct physical transfer and for remote locations, where communications is by other than face to face or direct physical exchanges or communications.

The disclosed invention is a system for an e-commerce or catalog merchant, as would be known to those skilled in the art, advertising and selling merchandise or services to remote buyers through diverse telecommunications such as for example the internet or the telephone or any other media now used or developed in the future, to authorize a third party establishment or an establishment of the seller, placed at a remote location to the seller, and local to the buyer or consumer, to act as an extension of the seller or the merchant and to establish and maintain a physical location where customers or buyers of the merchant can physically return merchandise or goods purchased remotely by computer based networked communications or via the telephone and which goods were shipped directly to the customer.

In describing the disclosed invention according to the disclosed inventive principles, seller and merchant, may be used interchangeably to describe the telecommunications connected buyer and seller and third party may be used interchangeably with agent of the seller or the seller itself, to describe a location which remote from the seller and at which the buyer may return the merchandise purchased from the seller directly to the third party, acting for the seller. The inventive system allows the third party at the remote location, to deal directly with the buyer while it can establish authenticity of a returned goods order against a database of executed transactions maintained by the merchant, as well as guidelines established by the merchant of it's return policies and a description of the item being returned and physical conditions and other parameters that establish the conditions for an acceptable return. Once authentication is established, the third party, whether acting as an authorized agent for the merchant or the merchant itself acting through it's employees, issues a credit to the buyer in the form of whatever commercial transaction media or means is established by the merchant as acceptable (cash, credit against a credit card, account credit, store credit, smart card loading, electronic purse loading, cashiers check, electronic funds transfer, replacement product drop shipped by merchant, etc). The third party then takes possession or title to the returned goods and returns them to the merchant according to pre-established procedures. In addition, a back-up system is established that enables authentication and authorization of return credits by means of the telephone system, should Internet access be unavailable at the time of the return transaction.

The disclosed system allows for the third party to ship the returned product directly to the original manufacturer or supplier (manufacturer). This requires increased connectivity between the manufacturer, merchant seller and third party and agreement between these parties to allow product returns to be consummated in this manner, and increase efficiencies in the return process.

As described in detail below in the detailed description of the invention, the operation of the disclosed system is a first stage called authentication, completed by means of a physical instrument identified below as the ReturnCERT, that the consumer, or customer, must present along with the returned item. This instrument is provided by the merchant, typically along with the original shipment, and establishes authenticity of the original purchase. Implementation of the instrument method is not specified, but could include means of bar code labeling, electronic media, or by means of a smart chip or card, as would be now or in the future known to those skilled in the art and that contains information that uniquely authenticates the original purchase. The authentication instrument could also be as rudimentary as a packing slip with a purchase order number printed on it or it could take the form of a verbally conveyed Return Material Authorization (RMA) Number obtained by the customer from the merchant. In addition, this instrument could be coded such that it could also be transferred to secondary goods recipients by the original customer as “gift cards” that establish authenticity but do not reveal the purchase price or any other information that it is desirable not to reveal. Once presented, the third party establishes an electronic link to the merchant's web site or domain as described above. Once a link is established, the third party has means to read, interpret and convert this instrument to electronic media that can then be electronically transmitted to the merchant via the Internet connection (or link) described above. In the case of a “smart” authentication instrument, such as a smart card or chip, once the reader interprets the instrument, the thirds party agent's computer system identifies the merchant's domain address and the identifying number of the original purchase and automatically links to the merchant's web site and provides the merchant with the identifying number of the original purchase. The merchant, upon receipt of this transmission from the third party agent, can establish authenticity of the return instrument and cross-reference that instrument to a purchase history maintained by the merchant. Once established, this authenticates that the person returning the goods has an instrument in their possession that traces back to a purchase from the merchant. This step could be further supplemented by having the third party request and receive traditional personal identification from the customer, such as for example, a driver's license.

The second stage called parameterization, allows the third party to review parameters defined by the merchant (and/or the manufacturer, in the case of returns directly to the manufacturer) that establishes the conditions for an acceptable return. This can include, but is not limited to, physical descriptions of the goods, quantity counts, packaging, general return policies, re-stocking fees, date of original purchase, warranties, acceptable physical condition, return window (dates) and any other data that enables the third party to act for the merchant in establishing whether or not the merchandise to be returned meets the conditions established for the return and may be accepted as a return. In addition, during this stage, information regarding the original financial instrument utilized by the customer, along with acceptable means of crediting the merchant provides that instrument, to the third party. Information related to whether or not the merchant is assuming return shipment costs or if these costs should be passed on to the customer, is also provided by the merchant to the third party at this stage. Information detailing required shipping packaging could also be provided. The parameterization process is accomplished by the third party reviewing material supplied by the merchant seller electronically via the electronic link established in the authentication stage described above.

The third stage, called presentation, is completed by means of the third party inputting results of the parameterization process described above into the computer system and transmitting this data to the merchant, to the extent required by the merchant. This could include condition of the returned goods, quantity, packaging, or any other parameter required by the merchant.

The fourth stage, called authorization, is accomplished by the merchant issuing electronic authorization to the third party to accept the returned goods and issue credit to the customer in a specified form and amount. Typically, this would be instruction to the third party via the Internet link to issue a credit in a dollar amount to the customer's credit card. This authorization can be either computer controlled or include a human invention and authorization step. The authorization step can also be expanded to allow authorization from the product manufacturer, in the case of a product being directly returned to the manufacturer and not being shipped back to the merchant.

The fifth stage, execution, is completed by the third party by physically taking possession of the returned goods and issuing credit to the customer by the customer's financial instrument, in whatever form used. This could also involve issuance of an exchange item by the merchant at the request of the customer via the third party agent. In the case of an item returned by a secondary goods recipient, for example, a gift recipient, the third party agent, acting on behalf of the merchant, would extend an alternate credit mechanism to the secondary goods recipient's financial instrument or provide other means of financial compensation or goods exchange. This could take any form established by the merchant.

The sixth stage in operation of the disclosed system is, called for the purposes of describing the invention, reconciliation, is accomplished after the customer transaction is complete and involves the physical return of the goods to the merchant (or directly to the manufacturer, in the case of a direct return to manufacturer, bypassing physical return to the merchant) and financial reconciliation between the third party and the merchant (and manufacturer, if a direct shipment is made). As an alternate, the merchant may elect to empower the third party to act as a financial agent to the merchant and issue credit directly from the merchant's financial accounts. In any case, some form of physical and financial reconciliation is required to assure the merchant receives the returned goods and the third partyis not held accountable financially and is also compensated for the services (including shipping) provided.

There is also the ability, according to the disclosed inventive principles, to conduct each stage or step described above by means of a telephone connection and voice communications between the merchant and the third party agent, should computer Internet access be unavailable. This back-up system relies on a manual system that accomplishes the same steps described above but by means of voice communications between the third party and the merchant.

Also, should a customer's return request be rejected in any step of the aforesaid process, there remains the ability for the agent to return the goods to the merchant for a traditional return or exchange, effectively relieving the agent of any responsibility in ascertaining whether or not the return is acceptable. This effectively provides a safety valve to the third party agent, should sufficient doubt and disagreement between the customer and the agent exist surrounding the validity of a return.

In addition, there is the ability to enhance the system further and allow for the third part agent to ship the returned product directly to the original manufacturer or supplier (manufacturer). This requires increased connectivity between the manufacturer, merchant and agent and agreement between these parties to allow product returns to be consummated in this manner, but further increase efficiencies in the return process. In this instance, the steps described above would all be completed, except that the manufacturer would also be a party to the process, and the manufacturer's concurrence with the steps related to his interests would be obtained.

According to the disclosed inventive principles, the disclosed system and method has the capability for the third party or merchant to establish a standardized packaging scheme that would enable the customer to return the purchased goods in the shipping package it was received for re-use by the third party when returning the goods to the merchant. This would improve the efficiency of the return process.

All return transactions may be arranged to flow through a standard third party's processing system or through a standard application that resides on each merchant's system. This allows for uniformity of the application software amongst numerous merchants sellers and third parties.

Accordingly, the inventive principles and method are of a system using a telecommunications network for the direct physical return of merchandise, purchased by a buyer from a seller of said merchandise through a transaction over said telecommunications network, by directly returning the merchandise to a third party at a remote location from said seller and connected to said seller through said telecommunications network. By direct physical return to the third party is meant the direct return of the merchandise to the third party, by giving possession of the merchandise to the third party, as if the buyer was at the location of the seller, remote from the third party and actually returning the merchandise directly to the seller by giving possession to the seller instead of to the third party acting for the seller as a representative, authorized agent or as a satellite remote location of the seller. By remote location of the seller is meant a location of the seller separate from the buyer or third party, so a direct physical delivery or return of merchandise by transfer of possession from or to the seller is not permitted or convenient. By local location of the third party or location of said third party remote from said seller, is meant a location for the direct physical return of said merchandise by the buyer to the third party, by giving possession of the returned merchandise to the third party representative, authorized agent or satellite location of seller, as if the buyer were at the site of the seller making the physical return of the merchandise to the seller by giving the seller possession and title of the returned merchandise. The local location of the seller has a similar meaning of the seller's location for a direct physical transfer of merchandise by a transfer of its possession from the seller to the buyer.

What is shown and described according to the disclosed inventive principles and a preferred embodiment as described in detail below, is the operation of a system using a telecommunications network for the direct return of merchandise, purchased by a buyer from a seller of said merchandise through a transaction over said telecommunications network, by said return of said merchandise to a third party at a remote location from said seller and connected to said seller through said telecommunications network, by operation of the system for establishing authenticity of said merchandise by a third party at a local location of said third party for the direct return of said merchandise, remote from said seller, through a telecommunications network; for verifying said authenticity of said merchandise, by said seller through said telecommunications network and issuing an authorization for acceptance of said direct return by said third party at said local location of said third party; for providing to said third party, at said third party location, parameters for said acceptance of said direct return of said merchandise; for issuing a credit to said buyer for said direct return of said merchandise.

What is shown and described according to the disclosed inventive principles and a preferred embodiment as described in detail below, is a computer program made of a set of signals recorded on a medium for use in operating a data processor connected to a network for telecommunications for the direct return of merchandise, purchased by a buyer from a seller of said merchandise through a transaction over said telecommunications network, by said return of said merchandise to a third party at a remote location from said seller and connected to said seller through said telecommunications network, by operating said data processor for establishing authenticity of merchandise purchased by a third party at a local location of said third party for the direct return of said merchandise, remote from said seller, through a telecommunications network; for verifying said authenticity of said merchandise, by said sellerthrough said telecommunications network and issuing an authorization for acceptance of said direct return by said third party at said local location of said third party; for providing to said third party, at said third party location, parameters for said acceptance of said direct return of said merchandise; for issuing a credit to said buyer for said direct return of said merchandise.

As would be known to those skilled in the art, one or more data processors may be used as may be suitable, with any suitable telecommunications network for use of the invention.

### BRIEF DESCRIPTION OF THE DRAWINGS

FIG. 1 Illustrates the Prior Art practice of ordering merchandise over the internet, as one example of a telecommunications network and its return for credit.

FIG. 2 Illustrates a Top Level Diagram for the DotComReturns system and method described according to the disclosed inventive principles and with reference to the following drawings.

FIG. 3 Illustrates a Top Level Flow Chart for DotComReturns, starting with the ordering process and through to the completion of the return of the merchandise and crediting of the buyers account.

FIG. 4 Illustrates the Ordering Process with ReturnCERT, as shown in FIG. 2.

FIG. 5 Illustrates the Ordering Process Screen Displays.

FIG. 6 Illustrates the Ordering Process in relation to the ReturnCERT Flowchart

FIG. 7 Illustrates the ReturnCERT Generation Screen Display

FIG. 8 Illustrates the ReturnCERT

FIG. 9 Illustrates the ReturnCERT Generation Flowchart

FIG. 10 Illustrates the Return Process with ReturnCERT

FIG. 11 Illustrates the Return Process with ReturnCERT Screen Displays

FIG. 12 Illustrates the Return Process with ReturnCERT Flowchart

FIG. 13 Illustrates Parameterization

FIG. 14 Illustrates the Parameterization Screen Displays

FIG. 15 Illustrates the Parameterization Flowchart

FIG. 16 Illustrates Return Approval

FIG. 17 Illustrates the Return Approval Screen Display

FIG. 18 Illustrates the Return Approval Flowchart

FIG. 19 Illustrates Account Crediting

FIG. 20 Illustrates Account Crediting Screen Display

FIG. 21 Illustrates an Internet Failure Transaction Back Up System

FIG. 22 Illustrates A Secondary Purchased Goods (Gift) Recipient

FIG. 23 Illustrates A System to Directly Return Products Back to the Originating Manufacturer

### DETAILED DESCRIPTION OF THE DRAWINGS

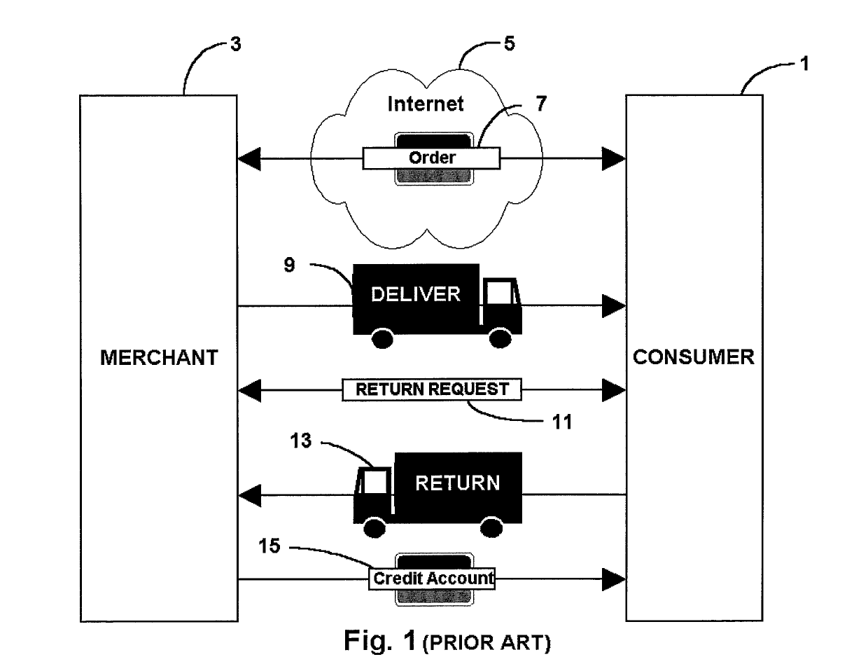

FIG. 1 depicts a typical prior art arrangement for purchase and return of goods ordered remotely via the Internet, from a seller at a location remote from the buyer and is also generally applicable to goods ordered via the telephone and catalog. The consumer or buyer 1 establishes an electronic connection to the merchant 3 via the Internet 5. The consumer 1 then places an order 7 utilizing a financial instrument 7, such as for example, a credit card. The merchant 3 then delivers 9 the product to the consumer 1. If the consumer 1 desires to return the goods, he initiates a return request 11 from the merchant 3, after which he must physically return 13 the goods to the merchant 3 at the merchant's remote location by giving possession or control or title of the merchandise to the merchant. Upon receipt and acceptance of the returned goods, the merchant 3, issues a credit 15 to the consumer 1.

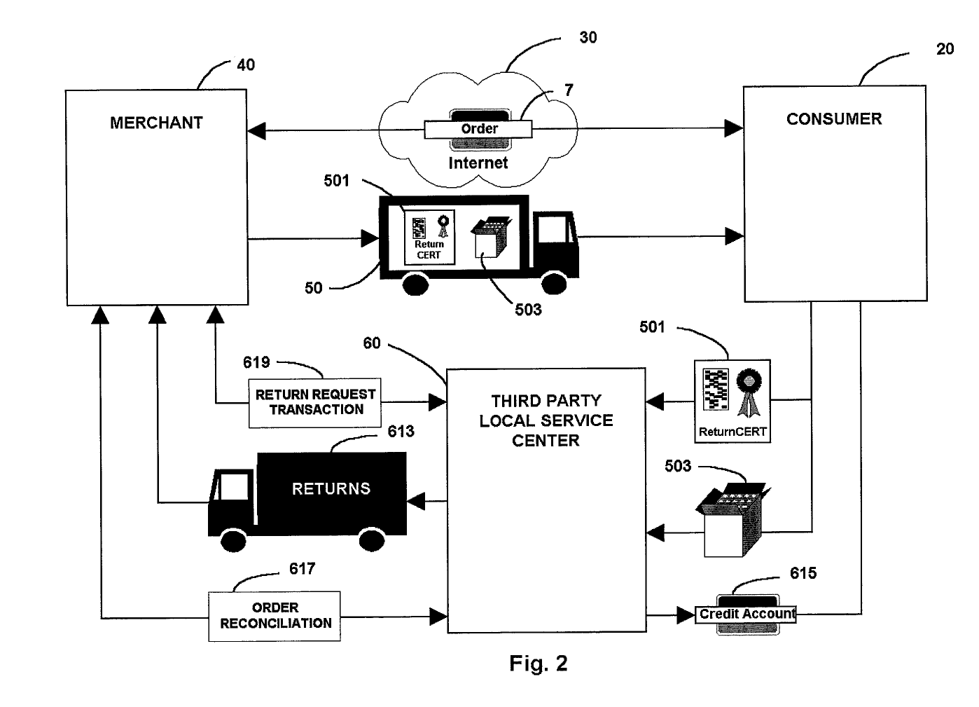

FIG. 2 provides a top level or over view of the inventive DotComReturns system and method. The remote ordering aspect of the process, such as by the internet, is similar to the method depicted in FIG. 1. The consumer 20 places an order 7 to the merchant 40 via the Internet 30. The merchant 40 delivers 50 the product 503 with a means for later authentication of the purchase, identified for the purposes of explanation as a ReturnCERT authentication instrument 501. If the consumer 20 does not like the product for a reason, the consumer takes the product 503 and the ReturnCERT authentication instrument 501 to the third party service center 60. The third party service center 60 verifies that the ReturnCERT 501 is authentic and initiates a return request transaction 619 to the merchant 40. If the product 503 matches the return criteria set up by the merchant 40, and sent to the third party in response, the service center 60 credits the consumers credit card 615. The third party 60 bundles and sends all of the returns 613 back to the merchant 40. On a periodic basis, the merchant 40 and the service center 60 reconcile all of the return transactions occurring since the previous reconciliation time.

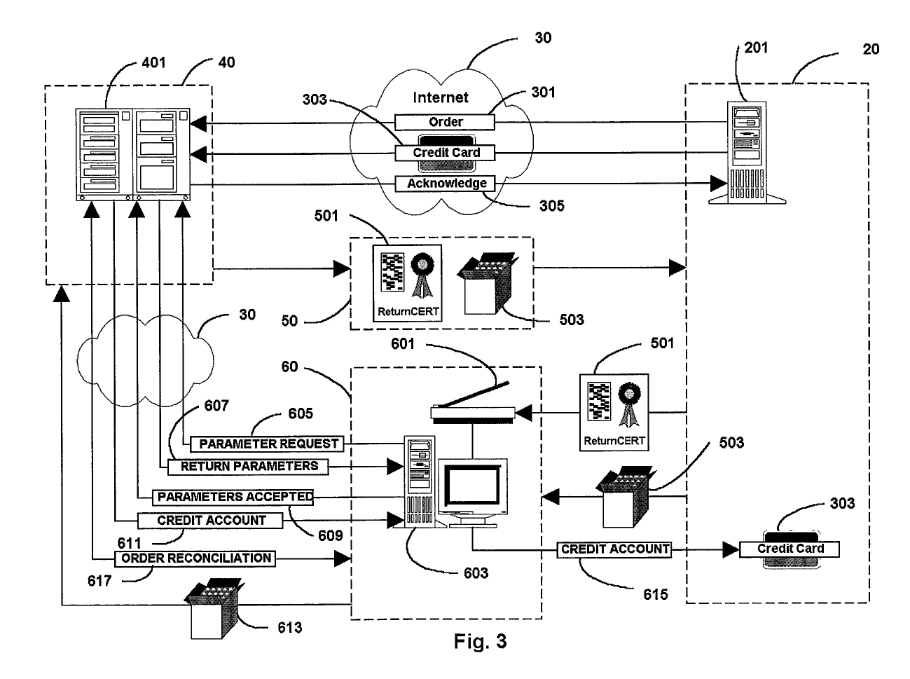

FIG. 3 provides a flow diagram of the return process, according to the disclosed inventive principles. The buyer or consumer 20 places an order 301 utilizing his computer 201 that is electronically connected to the merchant's computer 401 via the Internet, 30, for example. The consumer 20 supplies a financial instrument, in this illustration a credit card 303, to the merchant 40, utilizing the aforesaid Internet 30 connection. The merchant 40, then provides acknowledgement 305 back to the consumer 20, that the order has been accepted. The merchant 40, then ships 50 the product ordered 503, along with a ReturnCERT 501 document that uniquely and securely identifies the product 503 to the consumer 20. It is important to note that ReturnCERT is nomenclature describing a method to uniquely and securely identify a product and associate that product with a valid purchase. This association and secure identification can be realized by several different methods, as would be known to those skilled in the art, including the more traditional method of obtaining a Return Authorization by the consumer 20 directly from the merchant 40 by placing a telephone call to the merchant 40. In such a case, it would not be necessary for the merchant 40 to ship any authenticating ReturnCERT 501 document with the product. For the purposes of explanation, the description of a preferred embodiment as shown herein, uses the ReturnCERT method of Authentication but the invention and its use according to the disclosed inventive principles may use other methods of providing an acceptable level of authentication, as would be known to those skilled in the art.

Should the consumer 20 then wish to return the product 503, he can present the ReturnCERT 501 to a local third party 60. The third party 60 would then scan, using scanner 601 or in some other fashion interpret the ReturnCERT 501, as may be suitable or known to those skilled in the art, and link or enter the ReturnCERT 501 data into his computer system 603. The consumer 20 would also present the product ordered 503 to the third party 60 at this point in time. The third party 60, upon scanning 601 the ReturnCERT and identifying the product 503, would now have this data on its computer system 603 and would then establish an electronic connection to the merchant's 40 computer system 401. This connection could be established automatically once the ReturnCERT 501 is scanned by scanner 601. The merchant's computer system 401 would then compare this product return against a database of merchandise it has sold and which may represent potential returns and determine if the return process should continue. If there is a correspondence in the exchanged data and the return request appears legitimate, the merchant's computer system 401 provides the third party computer system 603, with a dialog request to initiate a return transaction. These steps form the basis for Authentication of the returned product 503 as a valid candidate return item.

At this point, where the return request appears valid, the third party 60 would initiate a Parameter Request 605 utilizing his computer system 603, which is electronically connected to the merchant 40. The merchant 40 would then automatically provide the Return Parameters 607 back to the third party 60. These parameters or conditions for the return 607 are then reviewed by the third party 60 and the product return 503 is compared to the parameters 607 provided by the merchant 40. If the product 503 and ReturnCERT 501 satisfies the Return Parameters 607 specified, the third party 60 initiates a Parameters Accepted 609 communication to the merchant 40. This step is referred to as Presentation, since it establishes the compilation and presentation of all parameters of interest to a merchant 40 regarding a product return request. Once the third party 60 provides this information to the merchant 40, along with his indication that the product 503 and ReturnCERT 501 comply with the return parameters 607, the merchant 40 must decide whether or not to accept the return request. This can either be done manually or through an automated or pre-established method.

Once accepted as a valid return, the merchant 40 issues a Credit Account 611 message to the third party 60. This serves as the basis for Authorization and allows the third party 60 to accept the returned product 503 on behalf of the merchant 40.

The third party 60 would now Execute the return transaction by physically receiving the product return 503 and issuing financial credit 615 to the consumer's 20 financial instrument, in this case a credit card 303.

The third party then packages the product return 503, along with the ReturnCERT 501, and ships the package 613, back to the merchant 40. Upon receipt of the return package 613 by the merchant 40, the merchant 40 and third party 60 perform a financial reconciliation 617 to acknowledge return of the product 613.

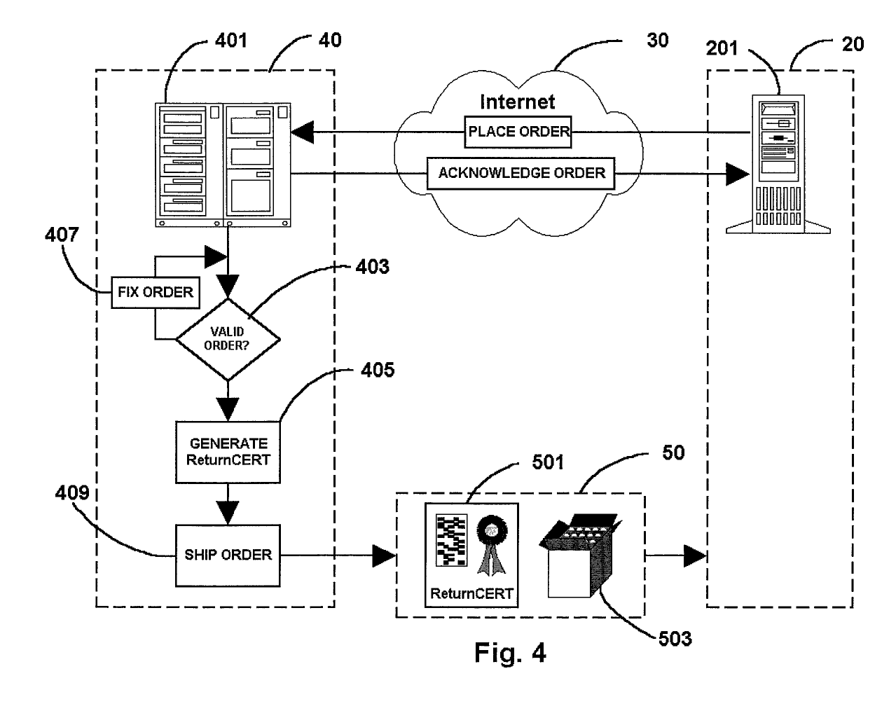

FIG. 4 shows the original order process using ReturnCERT as shown in FIG. 2, in more detail The consumer 20, places an order with the merchant 40 utilizing his computer 201, which is electronically connected to the merchant's computer 401 via the Internet 30. The merchant 40 must then determine if the order is valid 403. If not, the order must be corrected 407. If it is valid, the merchant 40 acknowledges the order to the consumer 20. The merchant 40 then generates a ReturnCERT 405 that matches the product 503 to the order and the consumer 20. The merchant then ships this order 409 in a package 50 that includes the ReturnCERT 501 and the product 503 to the consumer 20.

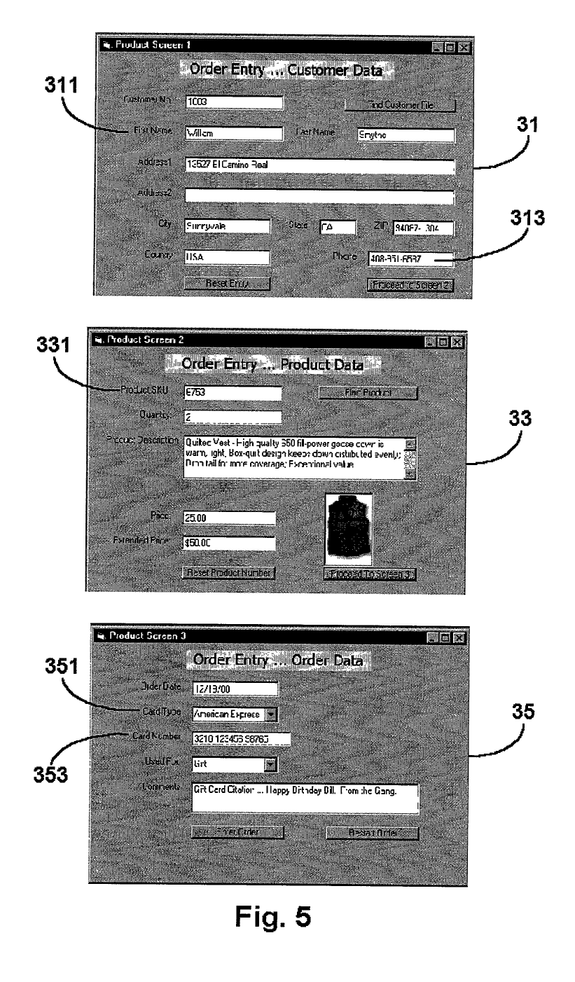

FIG. 5 illustrates the type of information that can be associated with a typical order entry and can be linked to a ReturnCERT document or method. As stated previously, it is not essential to this invention as shown in a preferred embodiment, that the ReturnCERT takes the exact form described herein, it merely illustrates a method of uniquely and securely identify a product and associate a candidate product return with a valid purchase, according to the disclosed inventive principles. In FIG. 5 a Customer Data order entry screen display 31 is shown, as may be used according to the principles of the disclosed invention, which includes such personal data for example, as a First Name 311 and Phone Number 313. Product Data 33 is also provided, such as product SKU 331. In addition, order data 35 is provided, such as credit card type 351 and number 353.

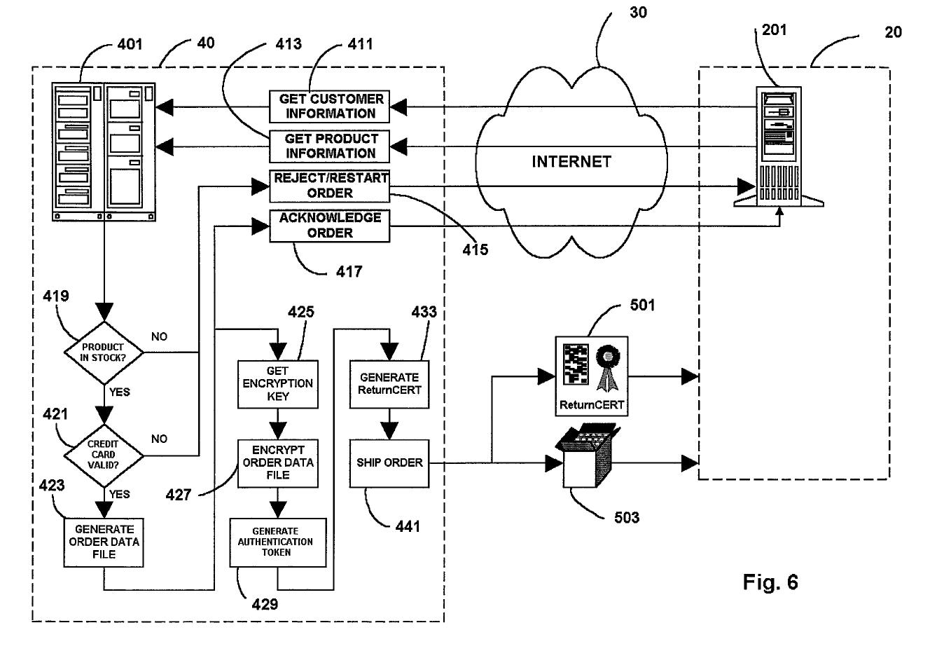

FIG. 6 is a flowchart depiction of the ordering process with the ReturnCERT capabilities illustrated. As the consumer 20 enters their order over the Internet 30 to the merchant's computer system 401, the merchant 40 requests customer information 411 and product information 413, such as quantity and type, from the consumer 20. At this point, the merchant's computer system 401 determines if the requested product is in stock or currently available 419. If not, the order is rejected/restarted 415 and the consumer 20 must modify it. In addition, the merchant 40 may check to verify that the credit card is valid 421. The merchant may also have other criteria as to the acceptability of the order. If these criteria are met, the merchant 40 generates an order data file 423 and acknowledges acceptance 417 of the order back to the consumer 20. The merchant then generates or otherwise obtains an encryption key 425, encrypts the order data file 427 and generates an authentication token 429. This in turn allows the merchant 40 to generate a ReturnCERT 433 and ship the order 441, which shipment will include the product 503 and the ReturnCERT 501, to the consumer 20.

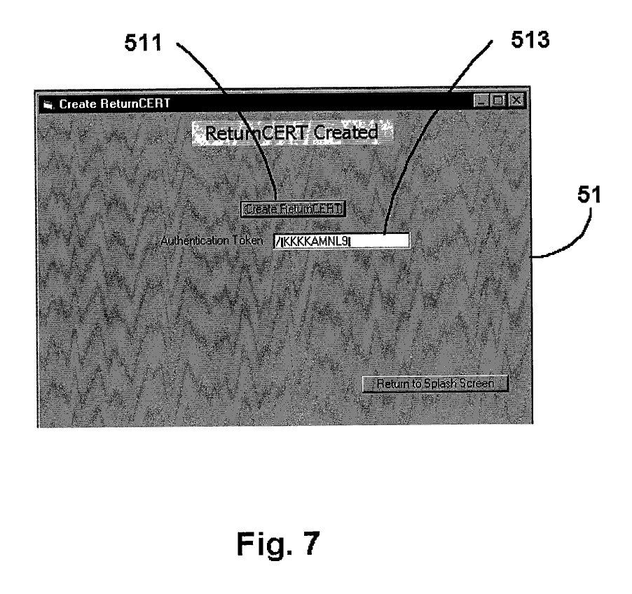

FIG. 7 illustrates an example of a ReturnCERT creation screen display 51. It includes a hot button 511, which maybe used in accordance with the disclosed inventive principles, to create the ReturnCERT and an Authentication Token entry field 513.

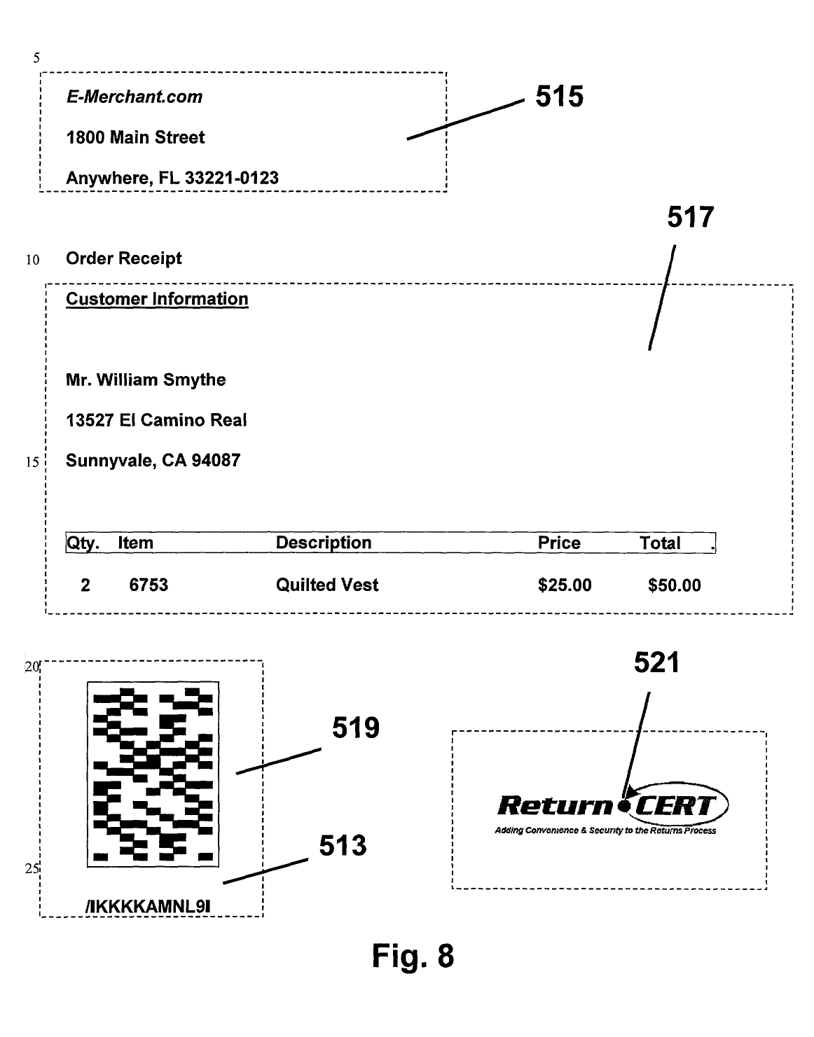

FIG. 8 shows a ReturnCERT document or ReturnCert as may be used in a preferred embodiment, but as would be understood by those skilled in the art may be varied for use in any suitable form as now or in the future known. The ReturnCert document provides the merchant's identification and return address 515, along with customer information 517, such as name and address and products ordered. The document also provides a unique identifying pattern such as for example, a 2-dimensional bar code 519 that securely identifies the order and the ReturnCERT logo 521 may be provided as a seal of authenticity.

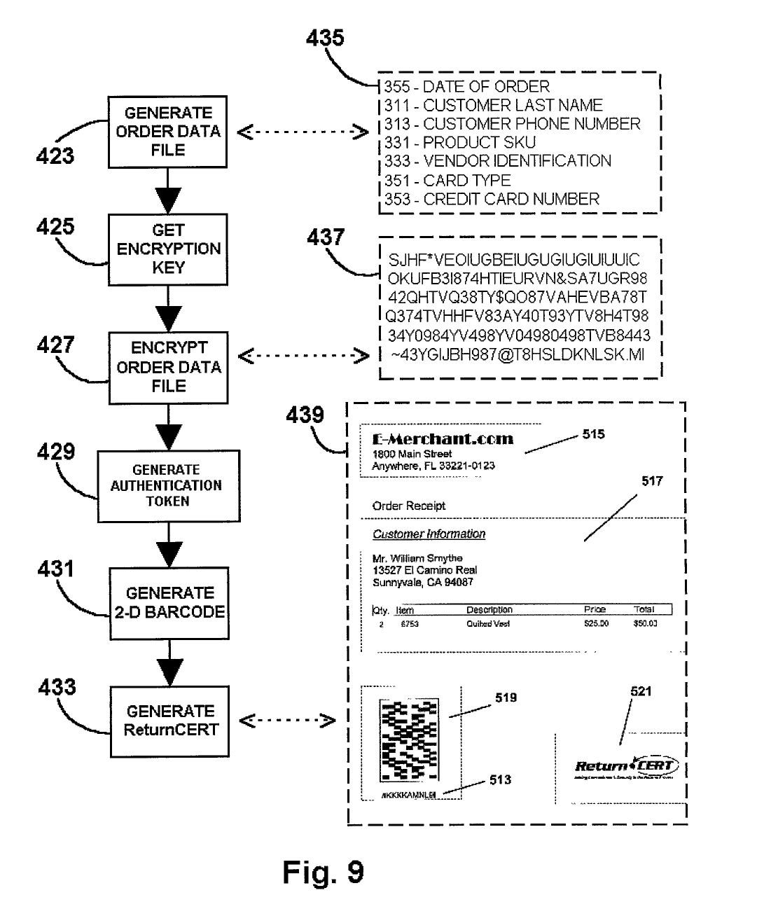

FIG. 9 depicts a process as may be used for generating the ReturnCERT 439. Once an order has been entered and completed, an Order Data File 435 is created 423 by the merchant's computer system. The merchant's computer then generates or otherwise obtains an encryption key 425 and uses that key to encrypt 427 the Order Data File 435 to produce a cipher text file 437 which can only be decrypted with a key, as would be known to those skilled in the art. An authentication token 513 is created 429 from the cipher text file 437. The cipher text file 437 and the authentication token 513 are used to create a 2-dimensional barcode 519 containing a secure copy of the Order Data File 435. A ReturnCERT 439 is created 433 using information from the Order Data File 435, the 2-dimentional barcode 519 and the authentication token 513. A ReturnCERT logo 521 is also added to the ReturnCERT 439 for quick visual identification at the third party service center.

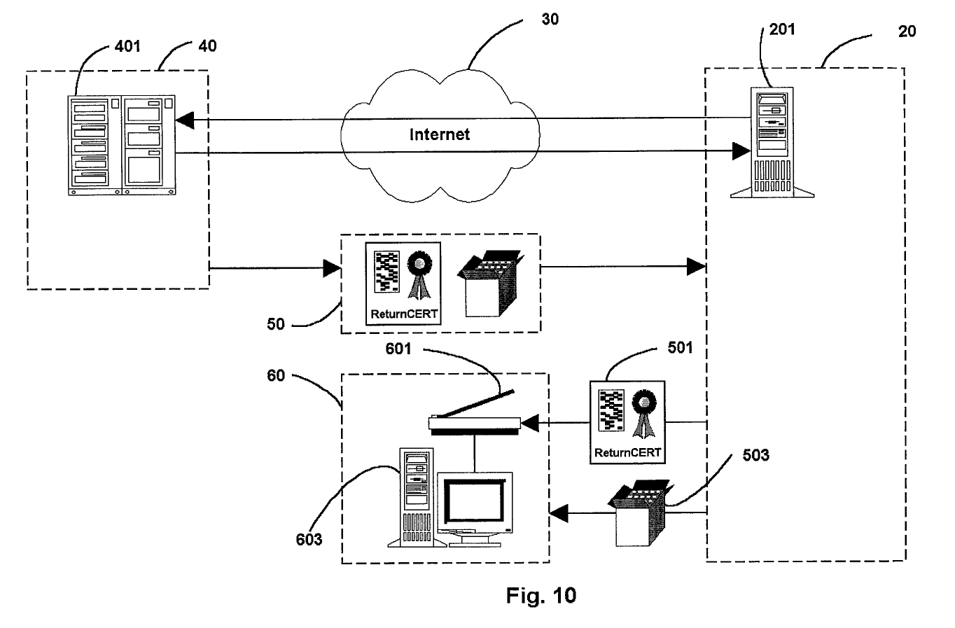

FIG. 10 illustrates that the customer 20 can take the product 503 along with the ReturnCERT 501 to the third party service center 60 in order to Return the product for credit to their credit card. The customer presents the ReturnCERT 501 to the clerk at the service center 60 who uses the scanner 601 to read the ReturnCERT. The scanner reads the information on the ReturnCERT 501 and enters the data into the service center's computer 603. The service center's computer 603 decodes the information on the 2-dimentional barcode on the ReturnCERT and uses this information to validate the order.

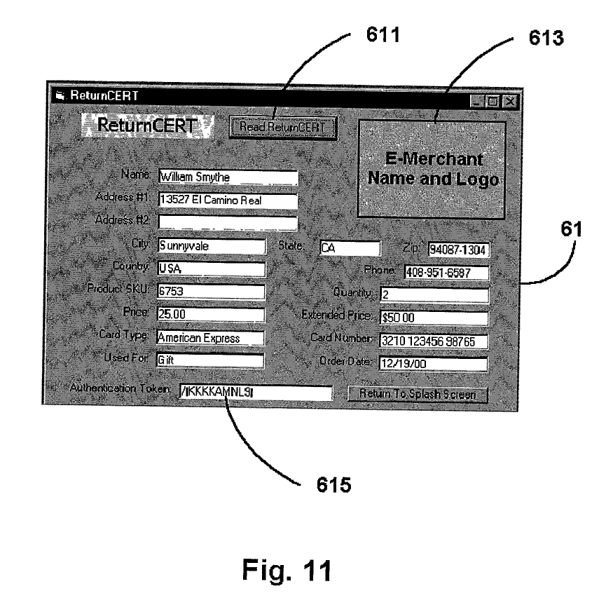

FIG. 11 shows an information entry screen 61 as may be utilized by a third party to enter the return data. This data is typically automatically populated once the ReturnCERT is read by a scanner for example by toggling a Read ReturnCERT hot button 611. The data includes the merchant's name and logo 613 and the authentication token 615. This data can also be entered manually if the ability to automatically read a ReturnCERT is not available or if a more primitive method is utilized, such as a sales receipt, Return Authorization Number, gift certifcate, or a “no questions asked” product return policy, that does not require any method to uniquely and securely identify a product and associate a candidate product return with a valid purchase.

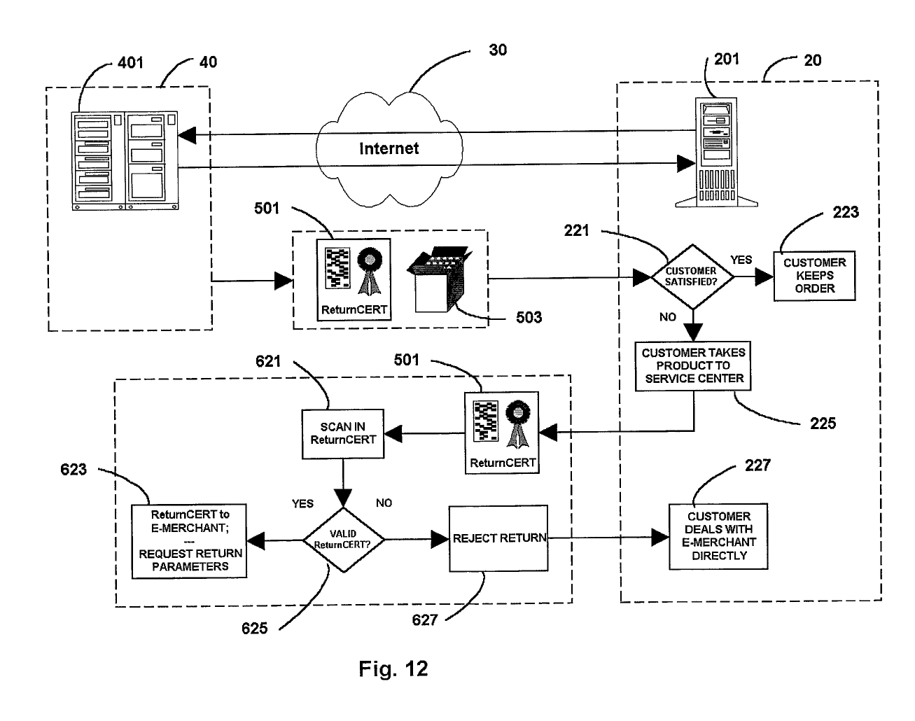

FIG. 12 provides a more detailed view of the flow process of FIG. 10, involved with the ReturnCERT return method. The consumer 20, orders a product 503 over the Internet 30 from a merchant 40, utilizing the consumer's computer system 201 and the merchant's computer 401. The merchant 40 ships the product 503 and ReturnCERT 501 to the consumer 20. The consumer then decides whether or not they are satisfied 221 with the product 503. If they are, they keep the product ordered 223. If not, the consumer 20 takes 225 the product 503 and ReturnCERT 501 to the third party service center. At this point, the ReturnCERT 501, is scanned 621 and a determination is made whether the ReturnCERT is valid 625. If valid, the ReturnCERT data is transmitted to the merchant to request parameterization data 623. If not, the return is rejected 627. In this case, the consumer 20, may deal directly 227 with the merchant 40 to resolve the return request. This capability is provided for any return request rejected by the third party for any reason.

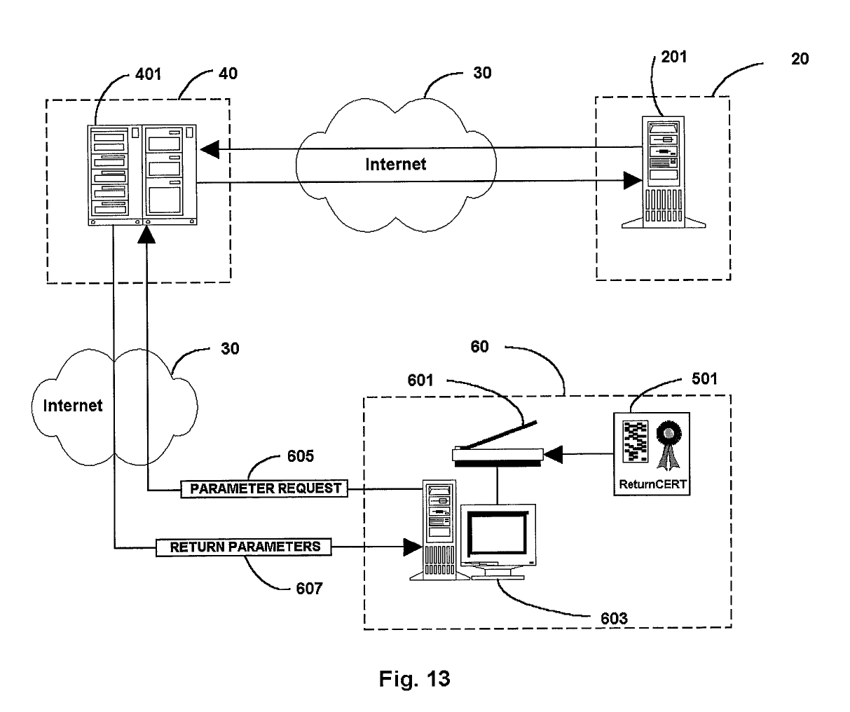

FIG. 13 depicts the scanning of the ReturnCERT 501 by the scanner 601 and the entry of the data into the third party service center's computer 603. Once the computer 603 has validated the ReturnCERT, a request 605 is sent to the merchant's computer 401 via the Internet 30. The merchant's computer 401 will validate the request and will then return 607 the inspection parameters to the third party service center.

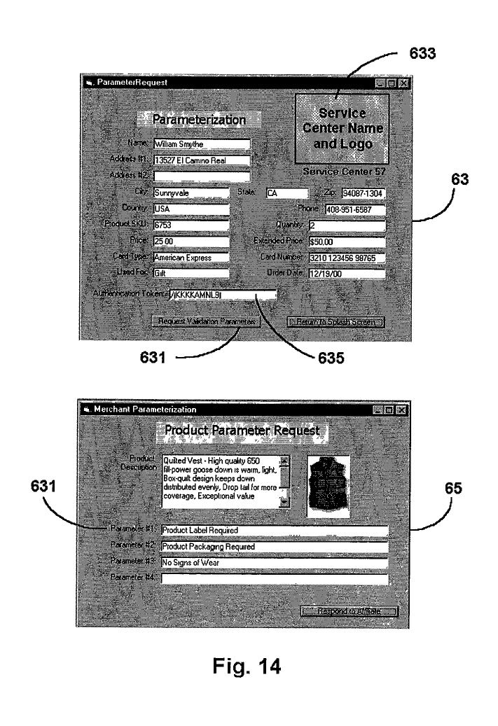

FIG. 14 illustrates the Parameterization Screen displays. When a third party requests parameterization data from the merchant, he is presented with a Parameter Request screen 63. This screen includes order data, the third party agent's name and logo 633, a field for the Authentication token 635 and a hot button 631 to transmit a request for parameterization. The response from the merchant to this request is depicted in a Merchant Parameterization screen 65, which would display parameters for acceptance 631.

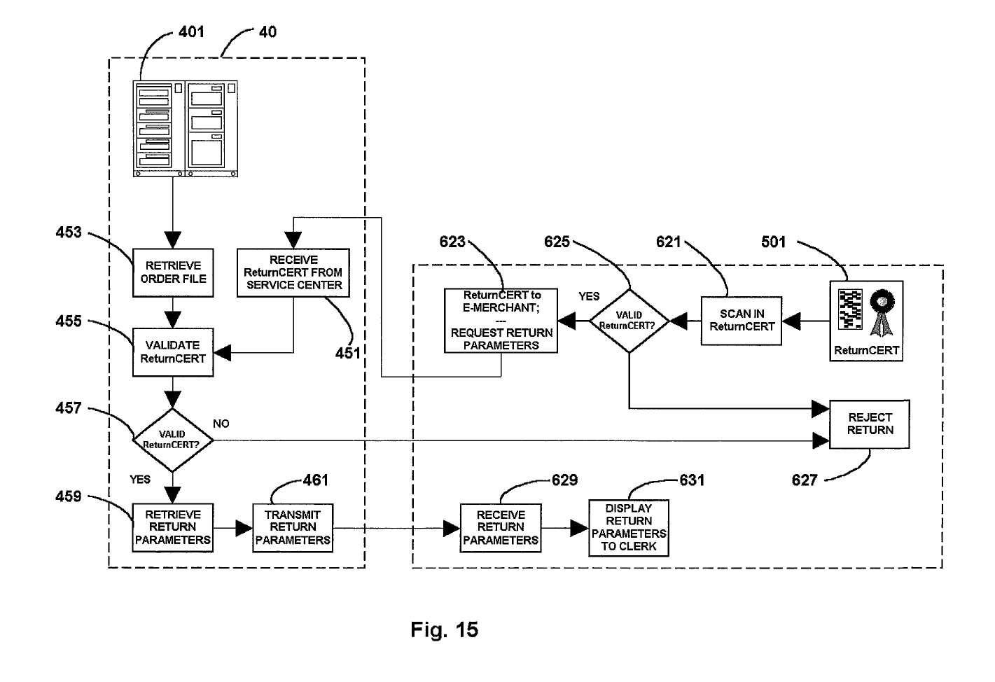

FIG. 15 is a detailed flow chart of the of the parameterization process. Once the ReturnCERT 501 has been scanned in 621 and validated 625 by the third party agent, it is sent 623 to the merchant along with a request for the return acceptance parameters. When the request comes to the merchant 451, the merchant's computer system 401 retrieves 453 the original order file from its database and compares 457 it to the ReturnCERT information obtained from the third party service center. If the merchant cannot validate the ReturnCERT, it sends a rejection notice to the third party service center 627. If the ReturnCERT can be validated, the return parameters are retrieved 459 from the merchant's database. The return parameters are then transmitted 461 to the third party service center. The third party service center will receive 629 the return parameters from the merchant and then display them 631 to the third party service center's clerk.

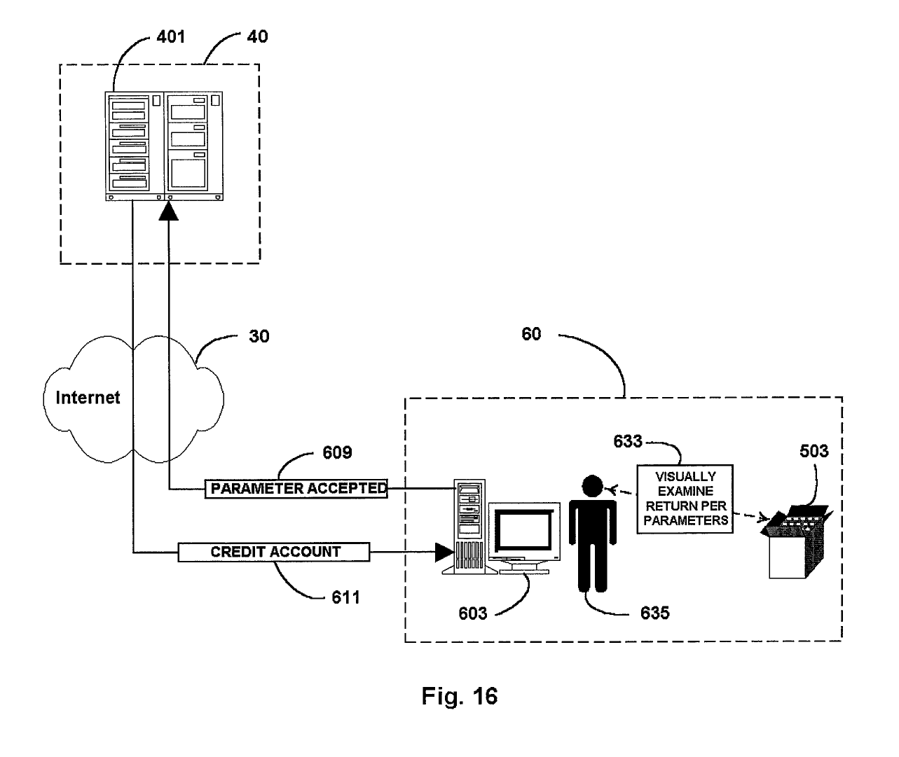

FIG. 16 depicts the return examination that occurs at the third party service center. The clerk 635 uses the return parameters received from the merchant 40 to visually examine 633 the product 503 being returned. If the returned product matches the return parameters specified by the merchant, the third party service center computer sends a “parameters accepted” notice 609 to the merchant 40. The merchant logs the acceptance notice and sends an approval 611 for the service center to credit the customer's credit card.

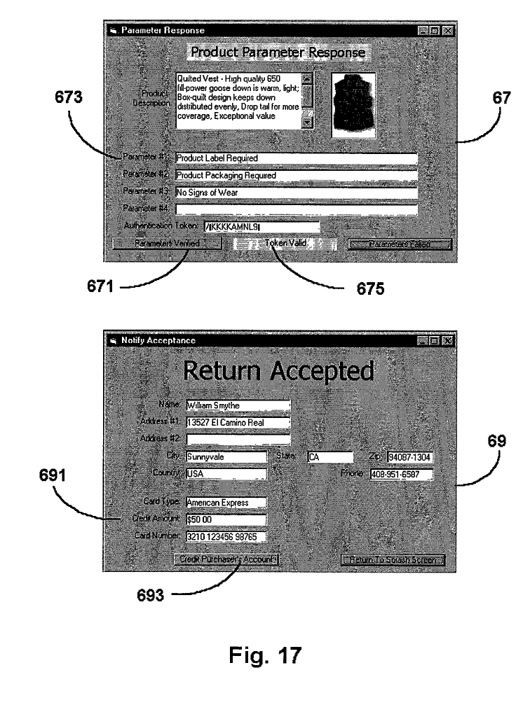

FIG. 17 displays screen displays of approval by the third party and the merchant. The Parameter Response screen 67, allows the third party to verify parameters 673, acknowledge they are met by utilizing a hot button 671, for example and receive the token's acceptance by the merchant by means of a display field 675. The merchant then acknowledges acceptance of the return request by transmitting the Return Accepted screen 69, which depicts financial credit amount 691 and provides the third party with a hot button capability 693 to credit the consumer's credit card or other financial instrument (including cash back).

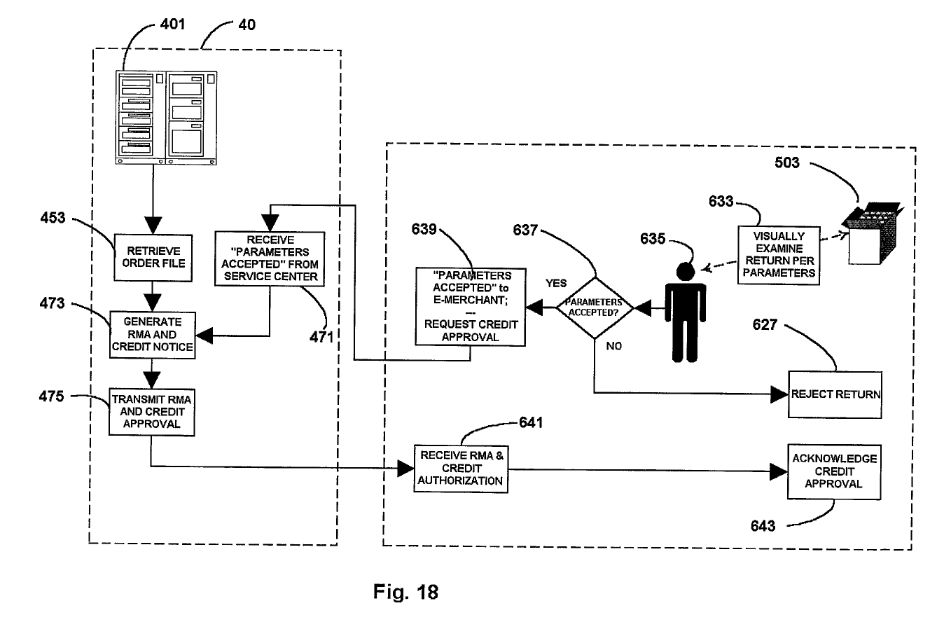

FIG. 18 depicts a flow chart of the acceptance process. The product 503 is inspected 633 by the third party service center agent 635 to determine if it meets the return criteria established by the merchant. If the parameters are not met “637-NO”, the agent informs the customer that the merchant has disapproved the return 627. In this case, or in the case of any dispute, the third party agent can offer the customer/consumer the ability to deal directly with the merchant and utilize a more traditional direct return process, in which case the customer deals directly with the merchant. If the criteria have been met “637-YES” a “Parameters Accepted” message is sent to the merchant. When the merchant receives the “parameters accepted” message from the service center, it retrieves 453 the original Order Data File from the computer 401. The merchant then generates 473 a Return Material Authorization and transmits the RMA along with the credit approval to the service center. The service center receives 641 the Return Material Authorization along with credit approval and notifies the customer of the acceptance 643.

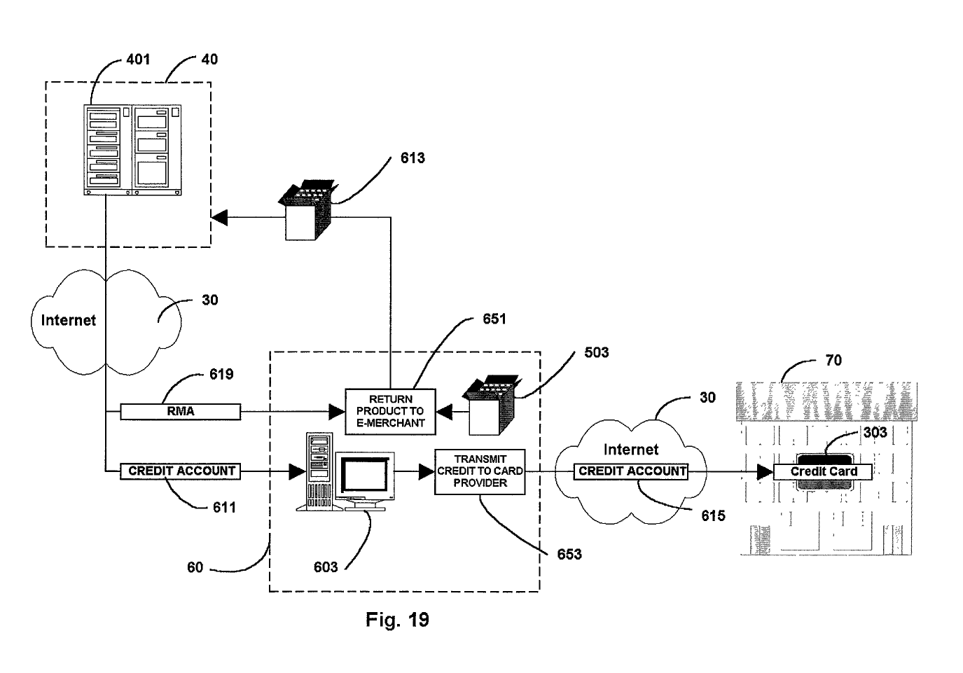

FIG. 19 depicts the flow of information and material during the credit and product return processes. When the merchant is satisfied that the product being returned has met all of its criteria, it sends a return material authorization 619 and credit message 611 to credit the customer's credit card account to the third party service center via the Internet 30, or as an alternative method, the merchant 40 links to the credit card issuer 70 and executes the credit transaction. The service center's computer 603 receives the credit account message 611 from the merchant and transmits 653 a message 615 to the credit card's financial institution 70 to credit the customer's credit card 303 via the Internet 30. The service center uses the return material authorization 619 to return the authenticated product 613 to the merchant.

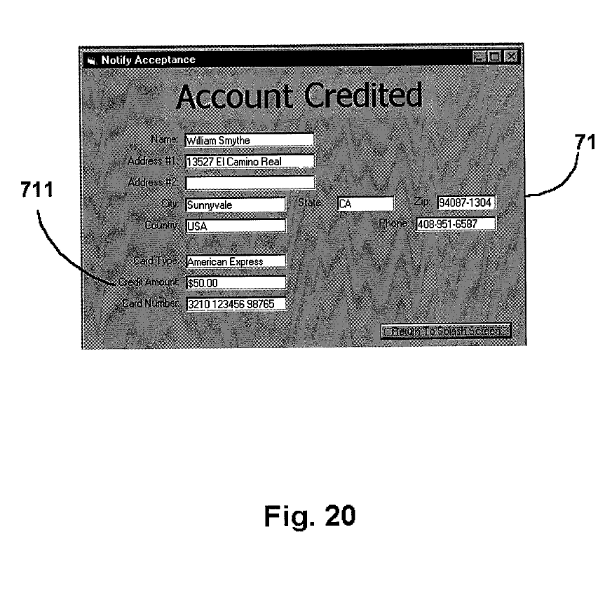

FIG. 20 illustrates a typical account credited screen 71. This screen is displayed in response to the credit request initiated by the Third party to the Merchant, and illustrates the form of credit 711. This screen includes the ability to print a credit form for use by the consumer that provides confirmation their account was credited.

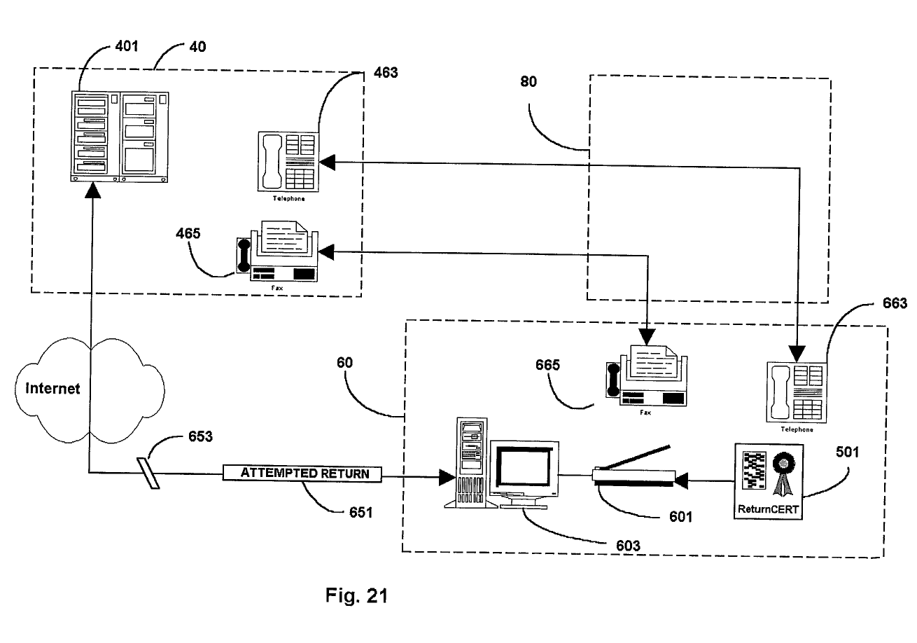

FIG. 21 depicts a back up system that enables a return transaction should the third party agent's access to the merchant's website via the Internet be unavailable, in which case the agent will establish a telephone connection directly to the merchant to conduct the return transaction. If the service center 60 cannot communicate with the merchant 40 via the Internet 30 due to a failure 653 of the Internet path between the service center and the merchant for any reason, the service center can use the public telephone network 80 to communicate via facsimile (665 to 465) or telephone (663 to 463) to accomplish the return process.

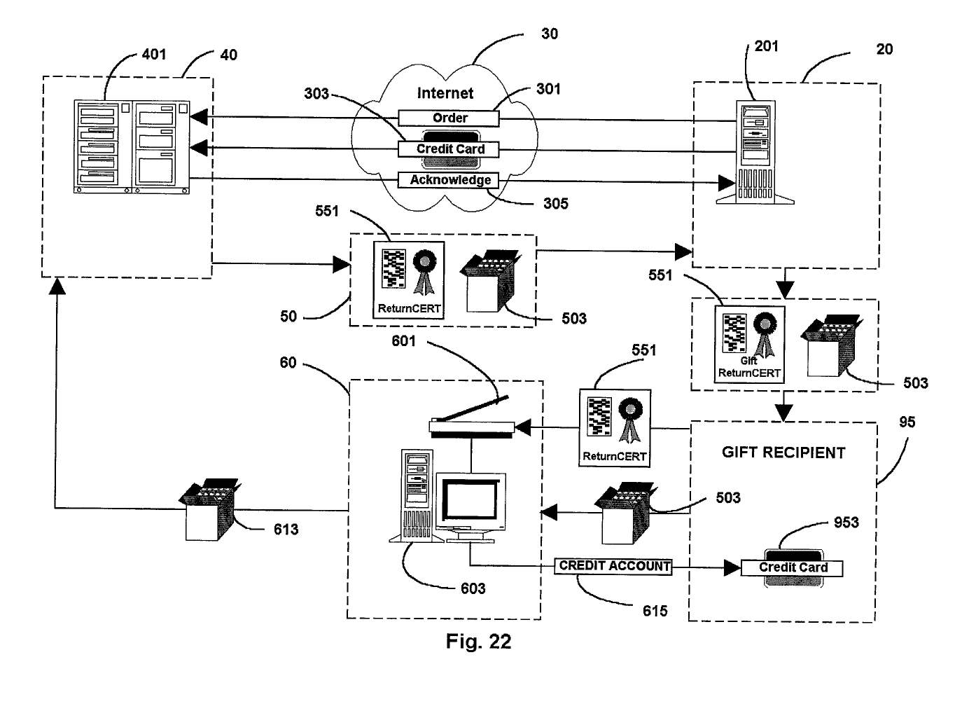

FIG. 22 depicts a secondary purchased goods recipient (gift recipient) return system. In this case the merchant provides the customer with the purchased goods 503 and gift ReturnCERT 551, who in turns transfers the goods to a secondary recipient 95 (gift recipient). The secondary recipient 95 then returns the goods 503 and authentication instrument 551 to the third party 60 who in turn returns the goods to the merchant 40 and issues credit to the secondary recipient's financial instrument 953, or issue a store credit or some other means of financial consideration.

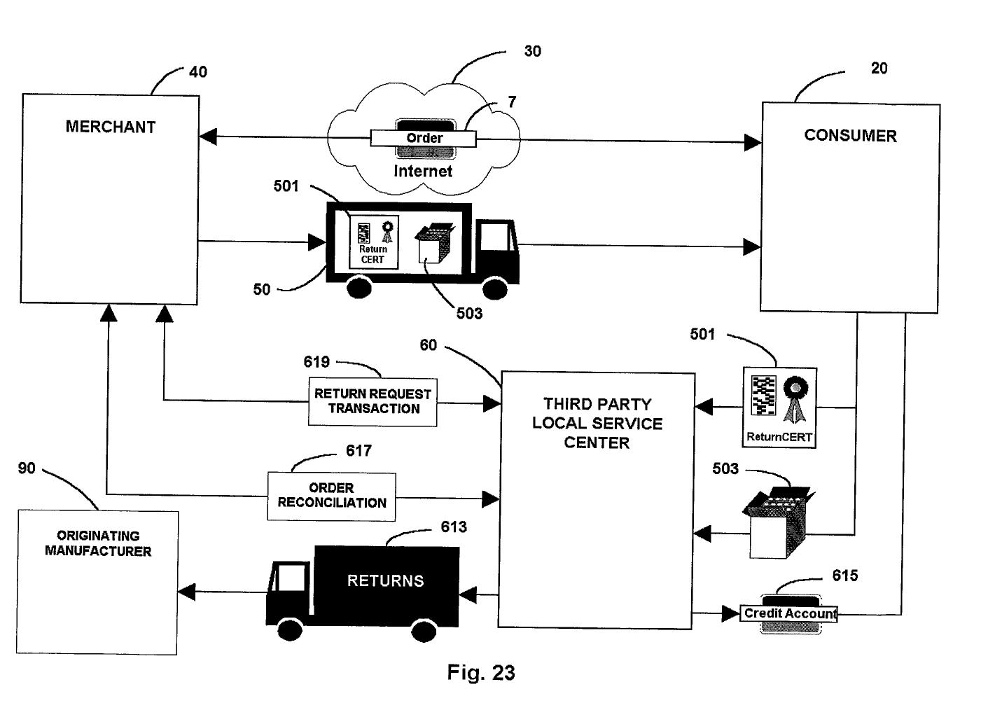

FIG. 23 depicts an arrangement that allows for the Third party to ship the returned product directly back to the originating manufacturer, bypassing physical receipt of the product by the merchant. The service center 60 bundles and sends all of the returns 613 back to the originating manufacturer 90 after receiving authorization from the merchant 40.

The computer data processing and network communications system which may be used to practice this invention may be any suitable system as would be now known or known in the future by those skilled in the art. The program for operating a computer data processing system and network communications system may be stored on any suitable media for use in operating the computer data processing and network communications system, as would be known to those skilled in the art, now or in the future.

1. A system using a telecommunications network for the direct physical return of merchandise, purchased by a buyer from a seller of said merchandise through a transaction over said telecommunications network, by said return of said merchandise to a third party at a remote location from said seller and connected to said seller through said telecommunications network, comprising,
a) means for establishing authenticity of said merchandise by a third party at a local location of said third party, through a telecommunications network, for the direct return of said merchandise at said local location of said third party;
b) means for verifying said authenticity of said merchandise, by said seller through said telecommunications network and issuing an authorization for acceptance of said direct return by said third party at said local location of said third party.

2. The system of claim 1, comprising,
c) means for seller to provide to said third party, at said third party location, parameters for said acceptance of said direct return of said merchandise.

3. The system of claim 1, comprising,
d) means for issuing a credit to said buyer for said direct return of said merchandise.

4. A method of using a telecommunications network for the direct return of merchandise, purchased by a buyer from a seller of said merchandise through a transaction over said telecommunications network, by said return of said merchandise to a third party at a remote location from said seller and connected to said seller through said telecommunications network, comprising the steps of,
a) establishing authenticity of said merchandise by a third party at a local location of said third party for the direct physical return of said merchandise, remote from said seller, through a telecommunications network;
b) verifying said authenticity of said merchandise, by said seller through said telecommunications network and issuing an authorization for acceptance of said return by said third party at said local location of said third party.

5. The method of claim 4, comprising the step of,
c) providing to said third party, at said third party location, parameters for said acceptance of said direct return of said merchandise.

6. The method of claim 4, comprising, the step of,
d) issuing a credit to said buyer for said direct return of said merchandise.

7. A program made of a set of signals recorded on a medium for use in operating a data processor connected to a network for telecommunications for the direct physical return of merchandise, purchased by a buyer from a seller of said merchandise through a transaction over said telecommunications network, by said return of said merchandise to a third party at a remote location from said seller and connected to said seller through said telecommunications network, comprising,
a) means for establishing authenticity of merchandise purchased by a third party at a local location of said third party for the direct return of said merchandise, remote from said seller, through a telecommunications network;
b) means for verifying said authenticity of said merchandise, by said seller through said telecommunications network and issuing an authorization for acceptance of said direct return by said third party at said local location of said third party.

8. The system of claim 7, comprising,
c) means for seller to provide to said third party, at said third party location, parameters for said acceptance of said direct return of said merchandise.

9. The system of claim 8, comprising,
d) means for issuing a credit to said buyer for said direct return of said merchandise.
